(19) United States
(12) Patent Application Publication
(10) Pub. No.: US 2006/0133335 A1
(43) Pub. Date: Jun. 22, 2006

(54) Establishing a push session in a communication system

(75) Inventor: Miguel-Angel Garcia-Martin, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/059,559

(22) Filed: Feb. 17, 2005

(30) Foreign Application Priority Data
Dec. 20, 2004 (FI) 20041634

(51) Int. Cl. H04Q 7/24; H04L 12/66

(52) U.S. Cl. 370/338; 370/352

(57) ABSTRACT

A method establishes a push session in a communication system. The method includes receiving a session invitation having a description of a push protocol over a transport protocol for establishing a push session. The method also includes setting up a transport bearer in accordance with the transport protocol. The method also includes using the transport bearer for a push session in accordance with the push protocol. A push gateway is configured to receive a submission to start a push operation towards the communication device and to transmit, based on the submission, the session invitation including the description to the communication device. A communication device is configured to execute the method.

### FIELD OF THE INVENTION

The invention relates to communication systems. More particularly the invention relates to establishing a push session in a communication system.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). A single communication system may interface with one or more communication systems, such as with other wireless systems, such as a wireless Internet Protocol (IP) network, and/or fixed line communication systems.

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. For example, a wireless application protocol (WAP) provides mobile communication devices services over wireless communication networks. Further examples of services may comprises, but are not limited to, short message service (SMS), multimedia messaging service (MMS), electronic mail (email), and so on.

A client of a communication device may request for a service or information from a server, which then responds in transmitting the requested service or information to the client. This may be referred to as a pull operation. An example of a pull operation may comprise a client allowing a user of a communication device to browse the Internet using a WAP or hypertext transfer protocol (HTTP) browser.

In an alternative, a server may transmit information or content without an explicit request from the client. This may be referred to as a push operation. Examples of push operation are discussed more in detail in the following.

A network operator or another party may configure in a communication device or provide the communication device with content or other information relating to the service. Examples of such information may comprise, but are not limited to, information relating to device management (DM). Further non-limiting examples of information may include news, stock quotes, weather, traffic reports and notification of events, such as email or MMS message arrival. The information may be transmitted to the communication device over the air (OTA).

The WAP Forum has defined a push OTA protocol for delivering content over the air from a push server to a communication device, such as a WAP enabled communication device. WAP Push Architectural Overview, Version 03-Jul-2001, Wireless Application Protocol, WAP-250-PushArchOverview-20010703-a, outlines the WAP push specifications, which together specify a service to push content to mobile devices via the WAP architecture. In a push operation, a push initiator (PI) may transmit push content and delivery instructions to a push proxy gateway (PPG), which may then deliver the push content to a client in the communication device according to the delivery instructions. A push initiator and a push proxy gateway may be separate entities or co-located in a single entity.

The push OTA is an application layer protocol that can be run on top of a wireless session protocol (WSP) for connectionless or connection-oriented push or on top of the HTTP for connection-oriented push. The push OTA protocol may thus be referred to as OTA-WSP and OTA-HTTP, respectively. For initiating connectivity, the PPG may send a request, such as a session initiation request (SIR), to a communication device to initiate connectivity. The request may be sent by connectionless push using the OTA-WSP, such as by means of an SMS. The communication device may then activate a bearer for a session as requested in the request and establish a session towards the PPG. The session may be a WSP or HTTP session or a transmission control protocol (TCP) connection.

It might be desired to provide alternative ways to provide information or content to a communication device. In particular, it might be desired to provide alternative ways which might reduce signaling in the network and re-use existing protocols and already established connections.

### SUMMARY OF TEH INVENTION

In accordance with an aspect of the invention, there is provided a method for establishing a push session in a communication system. The method comprises receiving a session invitation comprising a description of a push protocol over a transport protocol for establishing a push session. The method further comprises setting up a transport bearer in accordance with said transport protocol. The method further comprises using the transport bearer for a push session in accordance with said push protocol.

In an embodiment, the session invitation is received via an existing session initiation protocol signaling channel. In an embodiment, the session invitation may comprise an INVITE message of a session initiation protocol. The INVITE message may be received together with a session description protocol body, wherein said body comprises said description.

In an embodiment, the session invitation may carry the description for one of a device management session, a multimedia messaging service notification and a data synchronization session over one of a hypertext transfer protocol, a wireless session protocol, a use data protocol, a transmission control protocol connection and a transmission control protocol connection with transport layer security. In an embodiment, the session invitation may carry further information, wherein the further information may comprise at least one of a device management bootstrap and a device management session initiation message. In an embodiment, the further information may comprise notification of a multimedia messaging service message.

In an embodiment, the session invitation may be received for establishing a connection-oriented or connectionless push session and the transport bearer may be used for a connection-oriented or connectionless push session.

In accordance with a further aspect of the invention, there is provided a method for establishing a push session in a communication system. The method comprises receiving a submission to start a push operation towards a communication device. The method further comprises transmitting, based on said submission, a session invitation comprising a description providing information for establishing a push session for transmitting information between the communication device and an entity sending said submission.

In an embodiment, the session invitation may comprise the description of a push protocol over a transport protocol. In an embodiment, the session invitation may be transmitted via an existing session initiation protocol signaling channel.

In an embodiment, the step of transmitting may further comprise creating the session invitation comprising said description. In an embodiment, the step of transmitting may further comprise determining a session initiation protocol address or a telephone identifier of said communication device. In an embodiment, the step of transmitting may further comprise sending said session invitation to a session initiation protocol based core network for further routing towards said communication device.

In an embodiment, the method may further comprise monitoring progress relating to establishing the push session.

In an embodiment, the method may further comprise receiving said session invitation in the communication device, setting up a transport bearer between the communication device and the entity sending said submission in accordance with said transport protocol and using the transport bearer for a push session in accordance with said push protocol.

In accordance with another aspect of the invention, there is provided a computer program comprising program code means for performing any of the steps according to embodiments of the methods of the invention when the program is run on a computing means.

In accordance with another aspect of the invention, there is provided a communication device. The communication device is configured to receive a session invitation comprising a description of a push protocol over a transport protocol for establishing a push session. The communication device is further configured to set up a transport bearer between the communication device and an entity indicated in the session invitation in accordance with said transport protocol. The communication device is further configured to use the transport bearer for a push session in accordance with said push protocol.

In accordance with another aspect of the invention, there is provided a push gateway for a communication system. The push gateway is configured to receive a submission to start a push operation towards a communication device. The push gateway is further configured to transmit, based on said submission, a session invitation comprising a description providing information for establishing a push session for transmitting information between the communication device and an initiating entity from which the submission was received.

In accordance with another aspect of the invention, there is provided a communication system. The communication system is configured to provide a submission to start a push operation towards a communication device. The communication system is further configured to provide, based on said submission, a session invitation comprising a description of a push protocol over a transport protocol for establishing a push session. The communication system is further configured to provide the push session in accordance with the push protocol over the transport protocol.

In an embodiment, said push gateway may be configured to include, in said information, a description of a push protocol over a transport protocol and said communication system may further comprise at least one communication device configured to establish the push session in accordance with the push protocol over the transport protocol.

### BRIEF DESCRIPTION OF THE DRAWINGS

The invention will now be described in further detail, by way of example only, with reference to the following examples and accompanying drawing, in which:

FIG. 1 shows an example of an arrangement in which the embodiments of the invention may be implemented;

FIG. 2 shows a signalling chart illustrating an exemplifying embodiment of the invention; and

FIG. 3 shows a signalling chart illustrating another exemplifying embodiment of the invention.

### DETAILED DESCRIPTION OF PREFERRED EMBODIMENTS

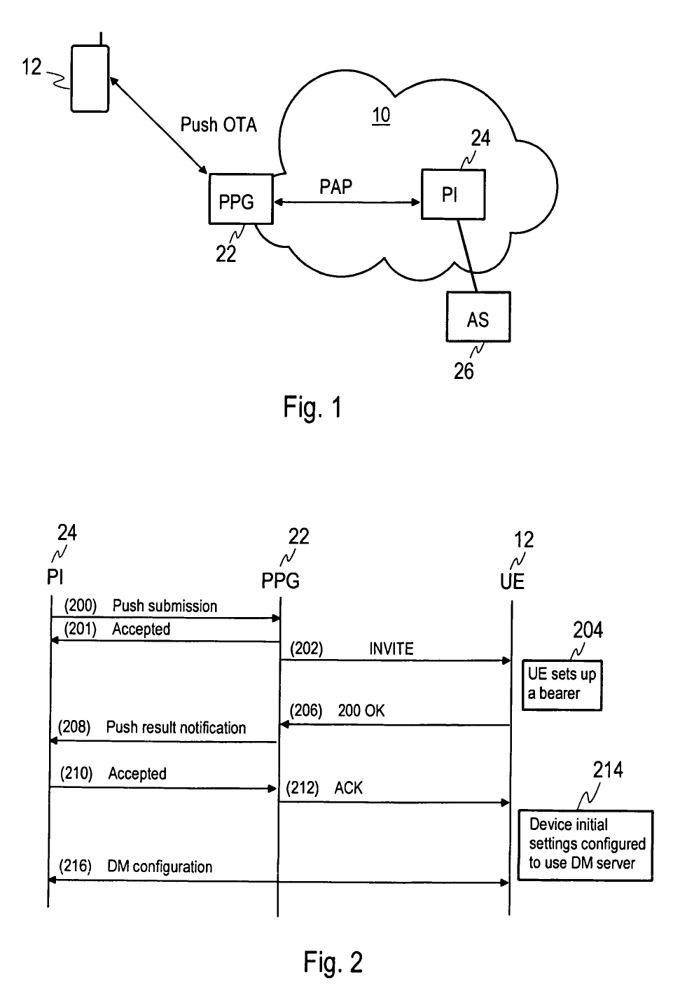

FIG. 1 shows an example of an arrangement including a communication network 10, a communication device 12, a push proxy gateway (PPG) 22 and a push initiator (PI) 24. Furthermore, an application server (AS) 26 is shown.

The PPG, or another push gateway or push entity, may implement network access-control policies about who is able to gain access to the network, that is, who is able to push content and who is not, under which circumstances, and so on. The PI 24 and the PPG 22 may communicate between each other using a push access protocol (PAP) as summarized in the document WAP-250-PushArchOverview-20010703-a. The PAP supports push submission, result notification, push cancellation, push replacement, status query and client capabilities query. In push submission, a message comprising a control entity, a content entity and optionally a capability entity is sent from the PI 24 to the PPG 22. The control entity contains the delivery instructions for the PPG 22. The control entity may be an extensible markup language (XML) document.

The PI, or another push server, may be a separate network entity or a single network entity with the push entity, such as with the PPG. In embodiments of the invention, the push server may be provided in a device management server, in a multimedia messaging service center (MMSC) or in another appropriate network entity.

It shall be appreciated that FIG. 1 is only an example showing only one communication network in connection with one communication device, one push proxy gateway together with one push initiator and one application server. The number and type of entities concerned in a communication system may differ substantially from that which is shown. The communication networks typically further comprise various switching and other control entities and gateways for enabling the communication for interfacing a single communication network with one or more communication networks. In order to enhance clarity, these control entities are not shown in FIG. 1. A communication system is typically arranged to serve a plurality of communication devices. Furthermore, a communication device may have several simultaneous communication sessions, for example a number of session initiation protocol (SIP) sessions and activated packet data protocol (PDP) contexts. Communication devices may be connected to the communication system from the same or different networks. Communication devices may access the communication network 10 via any appropriate access system. Examples may include, but are not limited to, radio access networks, e.g. an UMTS terrestrial radio access network (UTRAN) or a GSM/EDGE radio access network (GERAN), and short-range wireless systems, such as the Bluetooth, different types of fixed access systems, and so on.

A mobile communication network may logically be divided into a radio access network (RAN) and a core network (CN). The communication device 12 may access the communication network 10 via an access entity (not shown) of the RAN. The communication device 12 may, for example, wirelessly transmit and receive radio signals via a radio interface to and from a transceiver network element connected to the access entity. Correspondingly, the transceiver network element may wirelessly transmit and receive radio signals to and from the first communication device 12.

Services over wireless communication networks may use capabilities of, for example, the Internet Protocol multimedia (IM) core network subsystem (IMS). The IMS enables IP connections for a communication device and other parties to the communication, such as other communication devices or entities associated with the network. The third generation partnership project (3GPP) has defined use of the GPRS for offering IP connectivity to IMS services. The 3GPP has further defined a call control protocol for use in the IMS based on a session initiation protocol (SIP) and an associated session description protocol (SDP).

In an embodiment, the communication network 10 is a SIP controlled network. Further, in an embodiment, the communication network 10 is provided at least in part by the IMS. In the IMS, SIP based connection control is handled by SIP proxies called Call State Control Functions (CSCFs, not shown in the figure). Another appropriate SIP controlled communication system may be used as well.

In a 3GPP network, a packet data session is established to carry traffic flows over the network. Such a packet data session is often referred to as a packet data protocol (PDP) context. A PDP context may include a radio bearer provided between a communication device and a radio network controller, a radio access bearer provided between the communication device, the radio network controller and a serving GPRS support node (SGSN), and switched packet data channels provided between the SGSN and a gateway GPRS support node (GGSN). Each PDP context usually provides a communication pathway between a particular communication device and the GGSN and, once established, can typically carry multiple flows. Each flow normally represents, for example, a particular service and/or a media component of a particular service. The PDP context therefore often represents a logical communication pathway for one or more flow across the network. To implement the PDP context between the communication device and the SGSN, radio access bearers (RAB) need to be established which commonly allow for data transfer for the communication device. The implementation of these logical and physical channels is known to those skilled in the art and is therefore not discussed further herein.

The communication device 12 used by an end-user for accessing the communication network 10 may be any appropriate communication device, also called terminal. Examples may comprise user equipment (UE), a mobile station (MS), a cellular phone, a personal digital assistant (PDA) and a personal computer (PC). Further examples may comprise any other equipment operable according to SIP and preferably another suitable network or transport protocol, such as the WSP, the HTTP or the TCP.

A typical communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. A communication device is typically provided with a processor and memory means as well as software and applications operating the device and enabling operation with other entities. Software, which is able to request services from other entities in a communication system, may be called a client.

The session initiation protocol (SIP) is an application layer control protocol defined in document RFC 3261 “SIP: Session Initiation Protocol”, June 2002, by the Internet Engineering Task Force (IETF) for creating, modifying and terminating sessions with one or more participants. A user connected to a SIP base communication system may communicate with various entities of the communication system based on standardized SIP messages. Communication devices or user who run certain applications on the communication devices are registered with the SIP backbone so that an invitation to a particular session can be correctly delivered to these end points. SIP provides a registration mechanism for devices and users and it applies mechanisms such as location servers and registrars to route the session invitations appropriately.

The details of a session, such as the type of media, codec or sampling rate, are not described in SIP headers. Rather, a body of a SIP message may contain a description of a session, encoded in an appropriate protocol format. An example of such protocol format comprises session description protocol (SDP) defined in document RFC 2327 “SDP: Session Description Protocol”, April 1998.

Uniform Resource Identifiers (URI) are used to identify different types of actors in a SIP-controlled network. A URI may point to a registered user identity of an individual user, but may identify also other entities in the network, such as service provider servers or other types of resources.

The Third Generation Partnership Project 2 (3GPP2) has defined an MM1 interface as an interface between a multimedia messaging service user agent (MMS UA) and an MMS relay or server. The communication device 12 may implement the MMS UA. The application server (AS) 26 may implement the MMS relay or server. The MM1 provides message submission for the MMS UA to submit a multimedia message (MM), message notification for informing the MMS UA about a received MM, and message retrieval for the MMS UA for retrieving the received MM. SIP may be used for message submission and message notification and further for delivery acknowledgement, delivery reporting and read reporting over the MM1 interface. The procedure for message submission depends upon the content size of the MM. When the MM is small, the MM may be submitted directly in a submission request, that is the SIP MESSAGE request. When the MM is large or if otherwise required, the submission request contains an indirect reference to an MM. The indirect reference may contain an indication, such as a uniform resource identifier (URI), for referring to the MM content.

As summarized above, SIP may be used for MMS related information delivery. In the above-summarized solution, SIP may be used simply as a transport protocol carrying push messages relating to the MMS. Furthermore, SIP may be used as a transport protocol also for transmission of device management (DM) related information. When SIP is used only as a transport protocol, the push messages may be encapsulated into SIP messages, such as MESSAGE, NOTIFY and so on, which are not associated with a session.

It has now been found that instead of using SIP only as a transport protocol, SIP might be used to establish a push session, such as a device management (DM) session. Furthermore, it has been found that SIP messages carrying session initiation information, such as SIP INVITE, might be used for MMS notification or the like.

In this specification, term push session is used for a session composed of any particular protocol that requires pushing content, such as DM session, data synchronization (DS) session, MMS notification, and so on.

According to embodiments of the invention, session initiations using SIP may carry to a communication device 12 contents of the PAP received from the PI 24 to the PPG 22. As shown in FIG. 1, the contents of the PAP may originate from the application server 26. The contents of the PAP may originate from other sources as well. The content of the PAP may comprise XML encoded push messages that can be transported using the HTTP, WSP or TCP or another appropriate transport protocol.

Elements for the contents of PAP may comprise an identification of a high-level protocol for the push session as defined above, such a DM session, a DS session or MMS notification. Furthermore, said elements may comprise an identification of a point where the connection can be established. The point could be an IP address together with port number of the push initiator or another push server. In an alternative, the point could be a URI of the push initiator or another push server. An exemplifying URI might have a form:
“http://dm.example.com:8012”.

Furthermore, said elements may comprise an indication of a transport protocol. The transport protocol may be, for example, TCP, user datagram protocol (UDP), TCP with transport layer security (TCP+TLS), WSP, HTTP, and so on. The transport protocol should be included, in particular, if the transport protocol is not unique. The transport protocol may be regarded as unique, for example, when the point for connection is indicated as a HTTP URI, when the transport protocol is TCP. Accordingly, if the point for connection is indicated as a secure HTTP URI (HTTPS URI), the transport protocol is TCP+TLS. In an embodiment, the transport protocol may always be signaled in said elements.

In embodiments of the invention, the push session is treated as a media component, comparable to audio, video or session based messaging. According to embodiments of the invention, for example, a pure DM session over a TCP connection or a secure TCP connection, a DM session over the HTTP over the UDP or over the WSP may be established. Respectively, MMS notification or data synchronization or the like over TCP connection, TCP connection with TLS, HTTP, UDP or WSP may be performed.

In an embodiment, a SIP message, such as SIP INVITE, is provided with a message body, such as a SDP body. The message body contains description of a push protocol, such as a DM protocol, over a transport protocol, such as TCP, HTTP or WSP, for establishing a push session, such as for the DM session. In an embodiment, the description may comprise a description for DM session over HTTP comprising information of an IP address and a port of the PI, the URI representing the HTTP service at the PI, and/or other appropriate information. In a further embodiment, the description may comprise a description for a DM session over a TCP connection or over WSP.

In an embodiment, said DM protocol may comprise synchronization markup language (SyncML) device management protocol, which is described in SyncML Device Management Protocol, Version 1.1.2, Candidate Version 12-June-2003, Open Mobile Alliance, OMA-SyncML-DMProtocol-V1_{—}1_{—}2-20030612-C. Exemplifying protocols are given in section 11 of that document. In relation to MMS notification, a protocol format of an MMS message may be used.

Furthermore, the message body may comprise other information, such as a DM bootstrap and/or a DM session initiation message. Further examples of such other information may comprise MMS notification, and so on. In an embodiment, a first part of the other information is comprised in the SDP body and a second part of the information is comprised in a further body. Such further body may be carried by the SIP message in a similar manner as the SDP body. For example, a DM bootstrap message may contain many information elements, such as an IP address and a port number of the PI, quality of service, type of connection, required service, expiration time, and so on. Not all of these elements can be included in the SDP. Typically, the SDP may comprise the IP address and the port number of the PI, but not the further information, such as quality of service, type of connection, and so on. So in this exemplifying case, both the SDP and the DM message may complement each other. The SDP may be required by SIP to establish the session. In an alternative, the DM body may comprise the information on how to establish the session.

According to RFC 2327, an SDP session description comprises session-level description giving details that apply for a whole session and all media streams relating to the session. Furthermore, the SDP session description may comprise several media-level descriptions giving details that apply onto a single media stream. The SDP session description comprises a number of lines of text of the form <type>=<value>. <type> defines by means of one character the type of information given in the line in question.

In an embodiment, a push protocol, such as a DM, MMS or DS protocol, and a transport protocol, such as HTTP, TCP, UDP or WSP, are defined in a media-level description of an SDP session description. New values need to be defined for the “m=” line of the SDP defining media name and transport address and the subsequent “a=” lines providing media attributes.

According to RFC 2327, the “c=” line has a form c=<network type> <address type> <connection address>, and its purpose is to declare the IP address where the connection should be established.

According to an embodiment of the invention, the PPG creates an SDP body where the c= line is populated with the IP address of the PI. The communication device will later establish a connection to the IP address indicated in the SDP body.

According to RFC 2327, the “m=” line has a form m=<media> <port> <transport> <fint list>. In an embodiment of the invention, an exemplifying “m=” line may have a form:
m=application 80 oma-http-dm app/dm+xml

The above example defines application as a media type and a transport port to which the media stream will be sent. In this example, the port is 80 and defines the port for the PI. The transport protocol is defined as oma-http-dm to indicate that a HTTP session is to be established for carrying device management push information. Other transport protocols may comprise, for example, oma-tcp-dm, oma-wsp-dm, oma-http-mms, oma-tcp-mms and oma-wsp-mms. Other forms to indicate the transport protocol may be defined, as well.

In another embodiment of the invention, the connection address of the PI is provided in an “a=” line of the SDP as a complete URI. For example:
a=path:http://pi.example.com/dmservices

In an embodiment, the PPG 22 may establish a session by sending a session invitation, such as a SIP INVITE request, to the communication device 12. The session invitation contains a message body, such as an SDP body, that describes a media type, such as DM over TCP, HTTP or WSP as explained above. Furthermore, the message body includes the related capabilities supported by the PPG 22. The related capabilities may be indicated, for example, in the media attribute fields of the SDP session description. A call flow may follow a typical model where SIP preconditions are required. Said SIP preconditions may comprise that the communication device has local IP connectivity. Said preconditions may include a procedure to complete the reservation of resources in the communication device and in the network prior to sending media, for the purpose of getting an appropriate quality of service. In further embodiments, other preconditions may be set, if needed.

The communication device 12 may answer with a provisional response providing parameters and capabilities of the communication device relating to the media type defined in the session invitation, such as the DM parameters and capabilities of the communication device. Once the provisional response has been provided, or simultaneously when the provisional response is provided, the communication device 12 may start to set up bearers for the media type defined in the session invitation, such as HTTP bearers. When the bearers are set up, the communication device 12 may indicate so to the PPG 22 and accept the session. Then, one of the communication device 12 and the PI 24 establishes a required transport connection to the other of PI 24 and the communication device 12. Once the required transport connection is established, regular DM traffic may take place over a connection corresponding to the media type defined in the session invitation, such as over a TCP, HTTP or WSP connection. At any time, the PPG 22 can inform the PI 24 of the progress of the request.

FIG. 2 shows a signaling chart illustrating an embodiment of the invention. In signal 200, the PPG 22 receives push submission request from the PI 24. In signal 201, the PPG 24 sends a response, such as an acceptance, back to the PI 24. In signal 202, the PPG 22 sends a session invitation, such as a SIP INVITE, to the communication device 12. The session invitation comprises a description, such as a message body, for example an SDP body, providing information on a push protocol over a transport protocol for establishing a push method, such as a SIP push method. The description may comprise an IP address and a port of the PI or a URI that resolves to the IP address and port number of the PI. The communication device 12 sets up a transport bearer based on the information provided in the message body, referred to as 204 in FIG. 2. The communication device 12 accepts the session in signal 206, for example in SIP 200 OK. In signal 208, the PPG 22 notifies the PI 24 of a result of the session invitation. In signal 210 the PI acknowledges the reception of the Push result notification. The PPG acknowledges the reception of the 200 OK (206) message to the communication device 12 in signal 212. Initial settings of the communication device 12 are configured to use the PI 24 specified in the description, referred to as 214 in FIG. 2. A DM server may provide functionalities of the PI 24 if the session to be established is a DM session. If the signaling relates to MMS notification, the PI may be provided in an MMSC. Any other type of PUSH session is also possible. After configuration, the session, such as a DM session for DM configuration, may start, shown in signal 216 in FIG. 2.

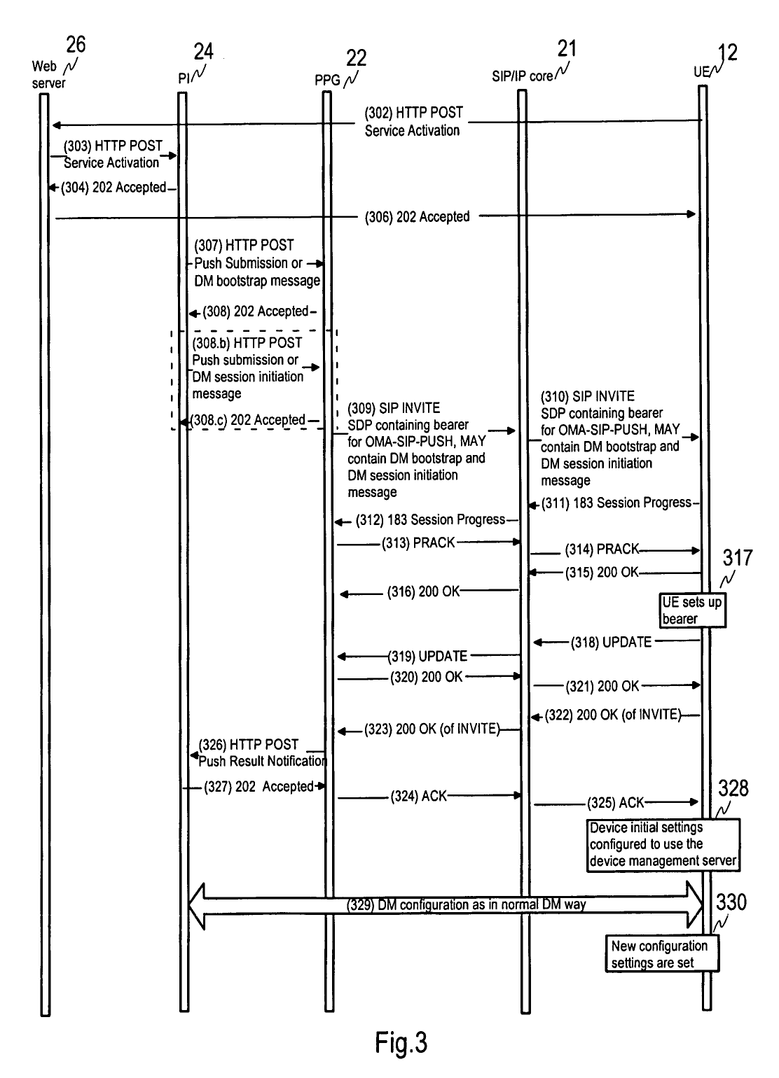

FIG. 3 shows a signaling chart illustrating a further exemplifying embodiment of the invention. For illustrating the signaling in a more complete manner, a further entity, SIP/IP core 21 is included in FIG. 3. The SIP/IP core, that is, a session initiation protocol based core network, may comprise a number of SIP proxies provided in the SIP controlled communication system.

A user using the communication device 12 activates a new service from a web page relating to a web server 26. This creates an HTTP POST request (signal 302) to the web server 26. The web server 26 indicates the PI 24, via another HTTP POST request (signal 303), service configuration parameters to be triggered to the communication device 12. The PI 24 and the web server 26 accept the HTTP POST request (signals 304 and 306). The PI 24 uses the PAP to create an HTTP POST request (signal 307) containing a push submission or a DM bootstrapping message. The PPG 22 accepts the HTTP POST (signal 308). Optionally, the PI may additionally send a DM session initiation message to the PPG (signal 308.b), which may be accepted by the PPG (signal 308.c).

The PPG 22 creates a SIP INVITE request (signal 309) addressed to the user. The INVITE request contains an SDP body that includes a media line (m=) that describes the setting up of a DM bearer including a transport. This SDP body also contains the capabilities related to DM supported by the PPG 22. Additionally, the SIP/SDP message may request that a DM session is established to the IP address and port of the PI 24 with so-called SIP preconditions. The SIP/IP core 21 routes the message and delivers the message to the communication device 12 (signal 310). The communication device 12 may request some interaction with the user or just continue with the session establishment automatically.

The communication device 12 answers with a 183 Session Progress message (signal 311) that contains the SDP, including a DM media description of the communication device, such as the IP address and port of the communication device. This message is delivered via the SIP/IP core to the PPG (signal 312). Appropriate acknowledgement and accept signaling may take place between the PPG 22 and the communication device (signals 313, 314, 315 and 316). The communication device 12 then establishes a bearer with appropriate quality of service (QoS) parameters for the DM, referred to as 317 in FIG. 3. The QoS parameters may relate to different classes of bearers, such as conversational, streaming, interactive and best effort. When the bearer is established, the communication device 12 sends an UPDATE message (signals 318 and 319) via the SIP/IP core to the PPG 22 to inform that the bearer is ready. The session is eventually established (signals 320, 321, 322, 323) and acknowledged (signals 324 and 325). The PPG 22 informs the PI 24 in an HTTP Push Result Notification message (signal 326), which may be accepted by the PI 24 (signal 327).

It is worth noting that the current description is based on the usage of SIP preconditions, but this not need be the case, e.g., if the communication device has already an established available transport bearer, or if the communication device will use a best effort bearer. The description based on SIP preconditions provides the most comprehensive description of the applicability of the invention.

At this point in time, the communication device will typically set up a transport connection (e.g. TCP, HTTP, WSP, UDP) to the PI address or port, referred to as 328 in FIG. 3. In an alternative, the transport connection may also be set up from the PI 24 to an address of the communication device 12. After that, regular DM message exchange, referred to as 329 in FIG. 3, takes place using the transport connection. New configuration settings are set in the communication device, as indicated by the reference 330. Since the DM message exchange does not constitute part of this invention, it shall not be further explained here.

Embodiments of the invention may re-use known DM protocol. In the invention, the transport protocol for transmitting a session initiation message from the PPG to a communication device is changed from HTTP or WSP or TCP to SIP.

When comparing embodiments of the invention with the existing OTA-HTTP or OTA-WSP described in the background section, embodiments of the invention may offer advantages at least for those mobile terminals that are already connected and using the IMS. When the PPG needs to send a request to a terminal, the terminal having already a SIP signalling channel (PDP context for signalling) established need not to establish a separate channel. This PDP context can be re-used for regular IMS (multimedia) traffic, OTA-SIP PUSH, and/or for the current DM/MMS session.

When comparing embodiments of the invention with a solution encapsulating a DM/MMS message in a SIP MESSAGE request, embodiments of the invention may allow the PPG to be informed about a status of the push actions. This is due to the usage of SIP preconditions and establishment of a regular DM session or other such session. A solution based on the SIP MESSAGE request may not offer the PPG with enough feedback for becoming aware of measures the communication device took with the encapsulated DM settings.

Embodiments of the invention may offer additional advantages because the PI does not need to be aware of a location of the communication device. There is no need to map the telephone number of the communication device with its IP address. This may be advantageous, as the IP address is dynamic and the communication device gets a different IP address every time when attaching to the network. The PI may simply address the communication device using the telephone number or other permanent identifier of the communication device. The PPG may send the telephone number to the IMS that may convert the telephone number to a SIP URI and then to the IP address the communication device is currently associated with.

In embodiments of the invention a TCP, HTTP or WSP connection is established. This requires establishing a radio bearer that can also be used for other actions, such as subscriptions to changes in the configuration, and alike.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices such as mobile stations, embodiments of the present invention may be applicable to other types of communication devices that may access communication networks. Furthermore, embodiments may be applicable to other appropriate communication systems, even if reference has mainly been made to mobile communication systems.

1. A method for establishing a push session in a communication system, the method comprising:
receiving a session invitation including a description of a push protocol over a transport protocol for establishing a push session;
setting up a transport bearer in accordance with said transport protocol; and using the transport bearer for the push session in accordance with said push protocol.

2. The method according to claim 1, wherein the step of receiving comprises receiving the session invitation via an existing session initiation protocol signaling channel.

3. The method according to claim 1, wherein the step of receiving comprises receiving an INVITE message of a session initiation protocol.

4. The method according to claim 3, wherein the step of receiving comprises receiving the INVITE message together with a session description protocol body, wherein said body comprises said description.

5. The method according to claim 1, wherein the step of receiving comprises receiving the session invitation, wherein the session invitation carries the description for one of a device management session, a multimedia messaging service notification and a data synchronization session over one of a hypertext transfer protocol, a wireless session protocol, a user data protocol, a transmission control protocol connection and a transmission control protocol connection with transport layer security.

6. The method according to claim 1, wherein the step of receiving comprises receiving the session invitation carrying further information, wherein the further information comprises at least one of a device management bootstrap and a device management session initiation message.

7. The method according to claim 1, wherein the step of receiving comprises receiving the session invitation carrying further information, wherein the further information comprises notification of a multimedia messaging service message.

8. The method according to claim 1, wherein the step of receiving comprises receiving the session invitation for establishing a connection-oriented or connectionless push session and the step of using comprises using the transport bearer for the connection-oriented or connectionless push session.

9. A computer program embodied on a computer-readable medium, said computer program configured to control a computing means to perform the steps of:
receiving a session invitation including a description of a push protocol over a transport protocol for establishing a push session;
setting up a transport bearer in accordance with said transport protocol; and
using the transport bearer for the push session in accordance with said push protocol

10. A method for establishing a push session in a communication system, the method comprising:
receiving a submission to start a push operation towards a communication device; and
transmitting, based on said submission, a session invitation including a description providing establishment information for establishing a push session for transmitting information between the communication device and an entity sending said submission.

11. The method according to claim 10, wherein the step of transmitting comprises transmitting the session invitation including the description of a push protocol over a transport protocol.

12. The method according to claim 10, wherein the step of transmitting comprises transmitting the session invitation via an existing session initiation protocol signaling channel.

13. The method according to claim 10, wherein the step of transmitting further comprises creating the session invitation comprising said description.

14. The method according to claim 11, wherein the step of transmitting further comprises determining a session initiation protocol address or a telephone identifier of said communication device.

15. The method according to claim 11, wherein the step of transmitting further comprises sending said session invitation to a session initiation protocol based core network for further routing towards said communication device.

16. The method according to claim 11, further comprising monitoring progress relating to establishing the push session.

17. A method according to claim 11, the method further comprising:
receiving said session invitation in the communication device;
setting up a transport bearer between the communication device and the entity sending said submission in accordance with said transport protocol; and
using the transport bearer for the push session in accordance with said push protocol.

18. A communication device configured to:
receive a session invitation including a description of a push protocol over a transport protocol for establishing a push session;
set up a transport bearer between the communication device and an entity indicated in the session invitation in accordance with said transport protocol; and use the transport bearer for the push session in accordance with said push protocol.

19. A communication device comprising:
receiving means for receiving a session invitation including a description of a push protocol over a transport protocol for establishing a push session;
setting up means for setting up a transport bearer between the communication device and an entity indicated in the session invitation in accordance with said transport protocol; and
using means for using the transport bearer for the push session in accordance with said push protocol.

20. A push gateway for a communication system, the push gateway configured to:
receive a submission to start a push operation towards a communication device; and
transmit, based on said submission, a session invitation including a description providing establishment information for establishing a push session for transmitting information between the communication device and an initiating entity from which the submission was received.

21. The push gateway according to claim 20, wherein the description comprises a push protocol over a transport protocol description.

22. The push gateway according to claim 20, configured to receive, in said submission, an Internet protocol address and port of the initiating entity and to indicate, in said session invitation, said Internet protocol address and port.

23. The push gateway according to claim 20, configured to receive, in said submission, a uniform resource identifier of the initiating entity and to indicate, in said session invitation, said uniform resource identifier.

24. The push gateway according to claim 20, further configured to convert submission information included in said submission into the session invitation of a session initiation protocol.

25. The push gateway according to claim 20, further configured to monitor progress of an establishment of the push session.

26. A push gateway for a communication system, the push gateway comprising:
receiving means for receiving a submission to start a push operation towards a communication device; and
transmitting means for transmitting, based on said submission, a session invitation including a description providing establishment information for establishing a push session for transmitting information between the communication device and a push initiator.

27. A communication system configured to:
provide a submission to start a push operation towards a communication device;
provide, based on said submission, a session invitation including a description of a push protocol over a transport protocol for establishing a push session; and
provide the push session in accordance with the push protocol over the transport protocol.

28. A communication system comprising:
at least one initiating entity for submitting push operations towards communication devices; and
a push gateway for transmitting to at least one communication device, based on a submission received from an entity of the at least one initiating entity, a session invitation including a description providing establishment information for establishing a push session for transmitting information between the entity and the at least one communication device.

29. The communication system according to claim 28, wherein said push gateway is configured to include, in said establishment information, a push protocol over a transport protocol description, said communication system further comprising the at least one communication device configured to establish the push session in accordance with the push protocol over the transport protocol.
